(19) United States
(12) Patent Application Publication
(10) Pub. No.: US 2026/0258819 A1
(43) Pub. Date: Sep. 3, 2026

(54) ACTUATOR FOR GROUND ENGAGING MACHINERY

(71) Applicant: Parker-Hannifin Corporation, Cleveland, OH (US)

(72) Inventor: Stuart JOHANSON, Buffalo, MN (US)

(73) Assignee: Parker-Hannifin Corporation, Cleveland, OH (US)

(21) Appl. No.: 18/867,670

(22) PCT Filed: Jul. 6, 2023
(86) PCT No.: PCT/US2023/069668

§ 371 Date: Nov. 20, 2024

Related U.S. Application Data
(60) Provisional application No. 63/389,965, filed on Jul. 18, 2022.

(51) Int. Cl. F15B 1/24; A01B 63/32; F15B 15/14

(52) U.S. Cl. CPC F15B 1/24; A01B 63/32; F15B 15/1428; F15B 2201/40

(57) ABSTRACT

A downforce control system for an agricultural ground engaging unit includes a hydraulic cylinder assembly including a cylinder chamber elongated along a longitudinal axis and a cylinder rod movable in the cylinder chamber along the longitudinal axis. Hydraulic fluid in the cylinder chamber provides a downforce on the cylinder rod to downwardly bias the agricultural ground engaging unit. The downforce control system further includes a first accumulator and second accumulator each being fluidly coupled to the cylinder chamber to receive at least a portion of the hydraulic fluid as the cylinder rod moves in the cylinder chamber and displaces hydraulic fluid from the cylinder chamber. Each of the first and second accumulators is elongated along a respective longitudinal axis and the respective longitudinal axes of the accumulators are offset and parallel to each other and are offset and parallel to the longitudinal axis of the cylinder chamber.

### RELATED APPLICATION

This application claims priority to United States Provisional Patent Application No. 63/389,965, filed Jul. 18, 2022 and titled “ACTUATOR FOR GROUND ENGAGING MACHINERY,” the entirety of which is incorporated herein by reference.

### TECHNICAL FIELD

The present invention relates to an actuator, and more particularly to an actuator for an agricultural ground engaging unit for use with agricultural implements.

### BACKGROUND

Agricultural planting machines commonly utilize a planter row unit that is towed behind a tractor for planting seeds in the soil. The planter row unit includes a plurality ground engaging units, each of which includes a furrow-opening device, a seed planting device, and a furrow-closing device for planting seeds in the soil. As the planter row unit travels across fields with variable soil conditions, such as different soil types, different moisture levels, topography, or the like, it can be difficult to maintain a constant seed depth due to the changing conditions. Accordingly, the ground engaging unit typically includes a downforce control system that is configured to maintain a constant downforce for maintaining a constant seed depth in response to the changing soil conditions.

### SUMMARY

Conventional downforce control systems utilize different types of biasing mechanisms (e.g., springs, airbag systems, etc.) to provide the flexible biasing force on the planter row units. However, these biasing mechanisms are difficult to adjust, requiring either manual replacement in the case of spring biasing mechanisms or manual air volume adjustment for airbag systems. Moreover, today's planters typically include many individual row units, each of which may encounter different soil conditions or debris, such as rocks etc., which requires each unit to float up or down independently, and thus adjusting each unit individually is time consuming and manually intensive. Furthermore, during towing, the biasing mechanism may experience a sudden force opposite the biasing direction and this sudden movement of the biasing mechanism may damage one or more components of the biasing mechanism.

At least one aspect of the present disclosure provides a downforce control system that includes a hydraulic cylinder that is biased downward by hydraulic fluid and at least two accumulators configured to temporarily store hydraulic fluid leaving the hydraulic cylinder when the pressure of the hydraulic fluid in the hydraulic cylinder is above a threshold amount, e.g., the hydraulic cylinder experiences a sudden force opposite the biasing direction causing evacuation of the hydraulic fluid from the hydraulic cylinder. Each accumulator can have a separate threshold amount such that hydraulic fluid only enters an accumulator when the pressure of the hydraulic fluid in the hydraulic cylinder is at or above the corresponding threshold.

Additionally, conventional agricultural planting machines have specific arrangements of hydraulic port locations, electrical component locations, etc. that result in a size constraint for attaching a downforce control system with a plurality of actuators to the planting machine without rearranging the machine infrastructure. Accordingly, at least one other aspect of the present disclosure provides a downforce control system that increases the compactness of the design by arranging the hydraulic cylinder and the accumulator(s) parallel to one another along their corresponding longitudinal axes and are retained within a singular housing such that the downforce control system can be utilized in existing planting machines with minimal changes.

According to an aspect of the disclosure, a downforce control system for an agricultural ground engaging unit, comprises: a hydraulic cylinder assembly including a cylinder chamber elongated along a longitudinal axis, and a cylinder rod movable in the cylinder chamber along the longitudinal axis, wherein hydraulic fluid in the cylinder chamber provides a downforce on the cylinder rod to downwardly bias the agricultural ground engaging unit; and a first accumulator and second accumulator, the first and second accumulators each being fluidly coupled to the cylinder chamber to receive at least a portion of the hydraulic fluid as the cylinder rod moves in the cylinder chamber and displaces hydraulic fluid from the cylinder chamber, wherein each of the first and second accumulators is elongated along a respective longitudinal axis, the respective longitudinal axes of the accumulators being offset and parallel to each other, and being offset and parallel to the longitudinal axis of the cylinder chamber.

According to another aspect of the disclosure, a downforce control system for an agricultural ground engaging unit, comprises: a hydraulic cylinder assembly including a cylinder chamber elongated along a longitudinal axis, and a cylinder rod moveable along the longitudinal axis, wherein the hydraulic fluid in the cylinder chamber provides a downforce on the cylinder rod; a first accumulator in fluid communication with the first chamber, wherein the first accumulator has a first threshold pressure above which fluid can be received by the first accumulator; and a second accumulator in fluid communication with the first chamber, wherein the second accumulator has a second threshold pressure above which fluid can be received by the second accumulator, wherein the second threshold pressure is greater than the first threshold pressure, wherein the hydraulic cylinder, the first accumulator, and the second accumulator are configured such that (i.) at least a portion of the hydraulic fluid from the first chamber is received by the first accumulator when the pressure in the first chamber is above the first threshold pressure and (ii.) at least a second portion of the hydraulic fluid from the first chamber is received by the second accumulator when the pressure in the first chamber is above the second threshold pressure, wherein the first and second accumulators each extend along a respective longitudinal axis that are offset and parallel to each other and are each offset and parallel to the cylinder longitudinal axis.

The following description and the annexed drawings set forth certain illustrative embodiments of the invention. These embodiments are indicative, however, of but a few of the various ways in which the principles of the invention may be employed. Other objects, advantages and novel features according to aspects of the invention will become apparent from the following detailed description when considered in conjunction with the drawings.

### BRIEF DESCRIPTION OF THE DRAWINGS

FIG. 1 illustrates an exemplary agricultural ground engaging unit with a downforce control system according to the present disclosure.

FIG. 2 illustrates the exemplary downforce control system of FIG. 1 in isolation.

FIG. 3 illustrates another view of the exemplary downforce control system of FIG. 1.

FIG. 4 illustrates the exemplary downforce control system of FIG. 1 in the extended position.

FIG. 5 illustrates the exemplary downforce control system of FIG. 1 with a portion of the housing removed.

FIG. 6a illustrates the hydraulic cylinder of the exemplary downforce control system of FIG. 1 in cross-section.

FIG. 6b illustrates the first accumulator of the exemplary downforce control system of FIG. 1 in cross-section.

FIG. 7 illustrates another exemplary embodiment of a downforce control system.

FIG. 8 illustrates a further exemplary embodiment of a downforce control system.

### DETAILED DESCRIPTION

Aspects of the present disclosure pertain to an actuator for an agricultural ground engaging unit for use with agricultural implements are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details.

In reference to the disclosure herein, for purposes of convenience and clarity only, directional terms, such as, top, bottom, left, right, up, down, upper, lower, over, above, below, beneath, rear, and front, may be used. Such directional terms should not be construed to limit the scope of the features described herein in any manner. It is to be understood that embodiments presented herein are by way of example and not by way of limitation. The intent of the following detailed description, although discussing exemplary embodiments, is to be construed to cover all modifications, alternatives, and equivalents of the embodiments as may fall within the spirit and scope of the features described herein.

Disclosed is a downforce control system that includes a hydraulic cylinder that is biased downward by hydraulic fluid and at least two accumulators configured to temporarily store hydraulic fluid leaving the hydraulic cylinder when the pressure of the hydraulic fluid in the hydraulic cylinder is above a threshold amount. To increase the compactness of the downforce control system and decrease the size, the hydraulic cylinder and the accumulator(s) are arranged parallel to one another along their corresponding longitudinal axes and are retained within a singular housing.

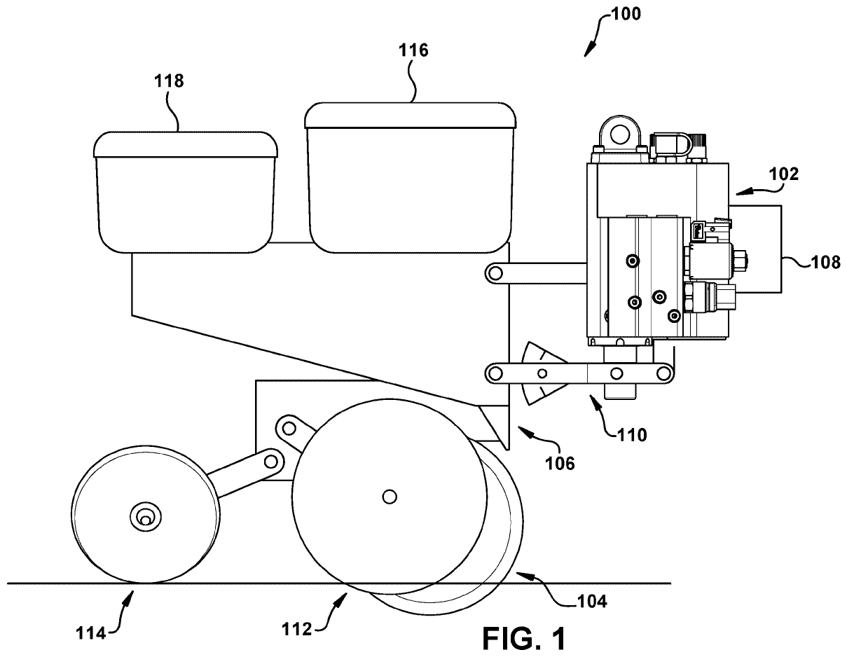

Turning now to FIG. 1, illustrated is an agricultural ground engaging unit 100 configured for the purpose of planting seed or injecting fertilizer into the soil, and a downforce control system 102 for providing a biasing force to a portion of the ground engaging unit 100 to flexibly maintain a desired planting or injection depth. The ground engaging unit 100 may be towed behind an agricultural vehicle, such as a tractor, and can further include attachment structure 108 to connect to the tractor, such as by a draw bar. The engaging unit 100 can further include a linkage assembly 110 that works in conjunction with the downforce control system 102 to raise and lower the engaging unit 100 as desired.

In the illustrated embodiment, the agricultural ground engaging unit 100 includes an opener 104 for penetrating the soil and creating a furrow in the soil. As shown, the opener 104 may be a V-opener formed by a pair of tilted discs extending from an engaging unit frame 106. As the ground engaging unit 100 is advanced by the tractor, the V-opener 104 penetrates the soil to form a furrow or seed slot. Other portions of the ground engaging unit 100 can then deposit seed in the seed slot and close the seed slot by distributing loosened soil into the seed slot with one or more closing wheels 114. The ground engaging unit 100 can further include a gauge wheel 112 used to determine the planting depth for the seed and/or the like. The ground engaging unit 100 may further include one or more containers for holding agricultural product deposited by the ground engaging unit 100. In the illustrated embodiment, the ground engaging unit 100 includes two bins 116 and 118 that can carry different chemicals, such as seeds, fertilizers, and/or the like. It will be understood that other ground engaging unit designs may be used with the downforce control system 102 described below.

The ground engaging unit 100 can be urged downwardly against the soil by its own weight and, additionally, the downforce control system 102. The downforce control system 102 can be located at any suitable location in the ground engaging unit 100 and in the illustrated embodiment, the ground engaging unit 100 is coupled between the attachment structure 108 and the linkage assembly 110. In addition to urging the engaging unit 100 downward, the downforce control system 102 can be used to lift the engaging unit 100 off the ground such that the V-opener 104 does not penetrate the soil.

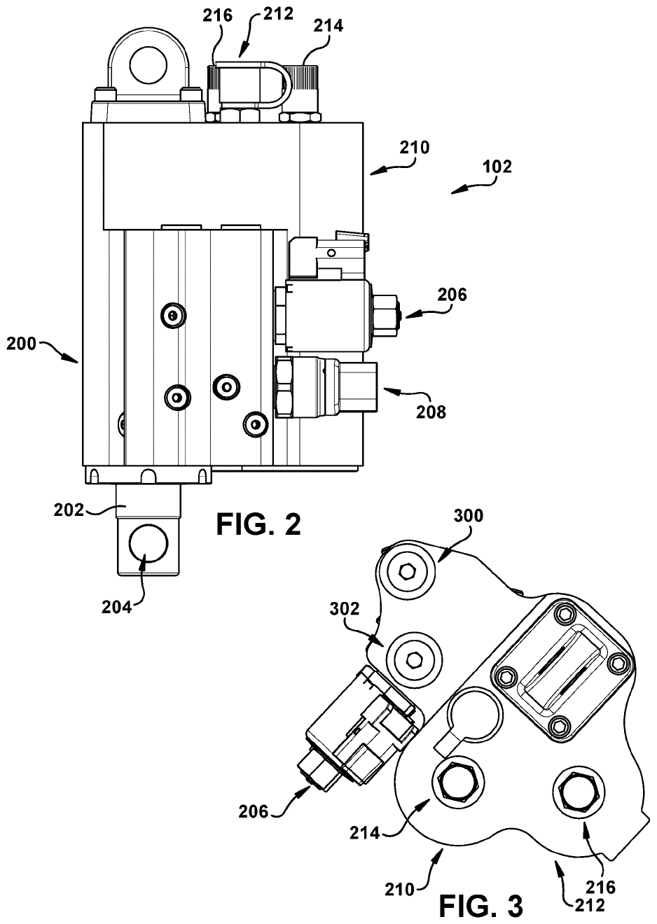

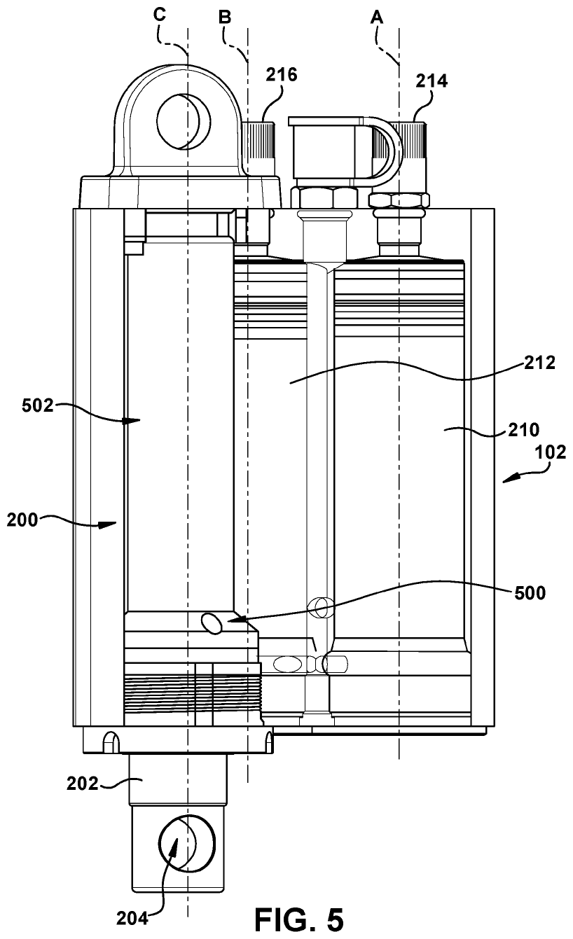

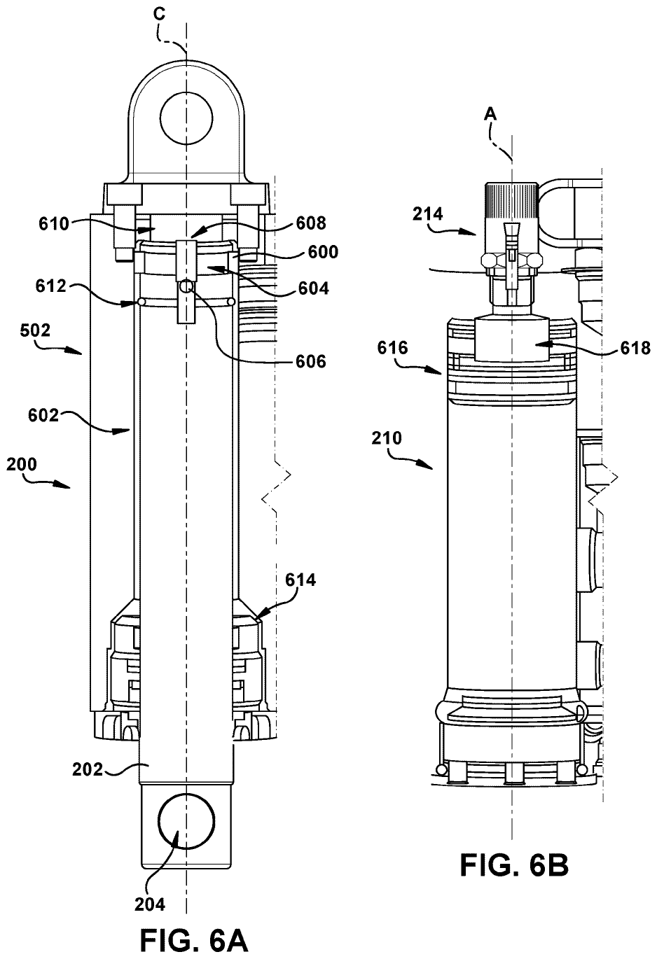

Turning now to FIGS. 2-3, an embodiment of the downforce control system 102 in isolation is illustrated. The downforce control system 102 includes a biasing mechanism for selectively biasing the engaging unit 100 upward and/or downward. Any suitable biasing mechanism can be used and different mechanisms may be used for different agricultural situations, such as size of the ground unit 100, soil being furrowed, and/or the like. In the illustrated embodiment, the biasing mechanism is a hydraulic cylinder assembly 200 with a cylinder rod 202 that travels in and out of a cylinder housing 500 (FIG. 5). An end of the illustrated cylinder rod 202 includes a connector, such as an attachment pin 204, for attaching the cylinder rod 202 to the linkage assembly 110 to bias the engaging unit 100 upward and downward as desired. In one embodiment, the hydraulic cylinder assembly 200 can be a single acting hydraulic cylinder where hydraulic fluid is provided to move the cylinder rod 202 in a first direction, while ground force, a spring or the like is used to move the cylinder rod 202 in a second opposite direction. In another embodiment, the hydraulic cylinder can be a double acting hydraulic cylinder where a first hydraulic fluid is provided in a first chamber 610 (FIG. 6a) to move the cylinder rod 202 in a first direction while a second hydraulic fluid is provided in a second chamber to move the cylinder rod 202 in a second opposite direction.

In the illustrated embodiment, the hydraulic cylinder assembly 200 is a single acting hydraulic cylinder with a supply port 300 of a control valve for providing hydraulic fluid to a first chamber 610 to move the cylinder rod 202 and a return port 302 of the control valve for removing hydraulic fluid as needed as the cylinder rod 202 moves. In another embodiment, the supply port 300 and the return port 302 are associated with two separate valves. More particularly, the supply port 300 can be associated with a supply valve and the return port 302 can be associated with a return valve that is separate from the supply valve. Accordingly, the downforce control system 102 can include one or more fluid connections between the hydraulic cylinder assembly 200, the supply port 300, and the return port 302.

The hydraulic fluid in the first chamber 610 can be used to achieve a desired output force via the cylinder rod 202 by providing a desired pressure on the cylinder rod 202 to press the cylinder rod 202 downward. The downforce control system 102 can further include a proportional control valve 206 which adjusts fluid pressure in the first chamber 610 to achieve a desired output force from the cylinder rod 202. The downforce control system 102 can further include a pressure sensor 208 to detect a pressure in the first chamber 610 to determine the output force and determine when the proportional control valve 206 needs to supply or vent hydraulic fluid from the first chamber 610 to the return port 302 and/or when more hydraulic fluid is needed in the first chamber 610 from the supply port 300 to maintain the desired pressure.

When the cylinder rod 202 experiences a force that overcomes downward force of the hydraulic fluid and presses the cylinder rod 202 back into the hydraulic cylinder assembly 200, the first chamber 610 is compressed causing the hydraulic fluid to flow out of the first chamber 610. In a conventional downforce control system, this exiting hydraulic fluid would then flow out of the return port 302 and into the return tubing. However, this sudden influx of hydraulic fluid on the return port 302 can result in ruptures at the return port, the return tubing, and/or the fluid connection between the hydraulic cylinder assembly 200 and the return port 302 which causes the downforce control system to begin leaking hydraulic fluid.

To overcome at least this issue, the downforce control system 102 described herein further includes two or more accumulators (e.g., accumulators 210 and 212) that can be configured selectively to receive a portion of the hydraulic fluid from the hydraulic cylinder before the hydraulic fluid reaches the return port 302 and/or supply port 300. The accumulator(s) function by temporarily storing a portion of the hydraulic fluid leaving the hydraulic cylinder assembly 200 to minimize pressure on the return port 302 and then providing the stored hydraulic fluid to the return port 302. For instance, the stored hydraulic fluid can then be provided at a different rate to the return port 302 compared to the conventional downforce control system. The accumulator(s) can store that hydraulic fluid for any suitable amount of time. In addition to temporarily storing hydraulic fluid exiting the first chamber 610 prior to reaching the return port 302, the accumulator(s) can be configured to provide stored hydraulic fluid to the first chamber 610 to move the cylinder rod 202 out of the hydraulic cylinder assembly 200. For instance, the accumulator(s) can act as a volume reserve to supply fluid to the first chamber 610 when a flowrate in or out of the chamber 610 exceeds a capability of the proportional control valve 206 to control flow in or out of the downforce control system 102.

The downforce control system 102 can include any suitable number of accumulators, such as a single accumulator and/or a plurality of accumulators. For instance, in the embodiment illustrated in FIGS. 2 and 3, the downforce control system 102 includes a first accumulator 210 and a second accumulator 212 (collectively referred to herein as “accumulators 210 and 212”). The accumulators 210 and 212 can be similar (e.g., shape, size, construction, etc.) and/or can vary. For instance, the first accumulator 210 may be a first accumulator type (e.g., a bladder accumulator), while the second accumulator is a different second accumulator type (e.g., a piston accumulator).

The accumulators 210 and 212 can each further have internal pressures that can define when hydraulic fluid can enter each of the accumulators 210 and 212. The internal pressure of each of the accumulators 210 and 212 can be generated via any suitable system and/or mechanism, as will be described in detail below. The internal pressure can act as a threshold to prevent hydraulic fluid from entering the accumulators 210 and 212 when the hydraulic fluid pressure in the first chamber 610 is below the threshold internal pressure. The internal pressures of the accumulators 210 and 212 can be similar and/or can vary. In one embodiment, the first accumulator 210 has a first internal pressure and the second accumulator 212 has a different second internal pressure that is higher or lower than the first internal pressure. For example, the first internal pressure is selected to permit hydraulic fluid to enter the first accumulator 210 anytime the pressure of the hydraulic fluid in the first chamber 610 is at or above pressure associated with the desired output force of the cylinder rod 202, while the second internal pressure is selected to permit hydraulic fluid to enter the second accumulator 212 only when the pressure of the hydraulic fluid in the first chamber 610 is above a threshold amount that is above pressure associated with the desired output force of the cylinder rod 202.

In addition to venting the hydraulic fluid to the return port 302, the first accumulator 210 and/or the second accumulator 212 can be further configured to provide stored hydraulic fluid back to the first chamber 610. For instance, when the ground engaging unit 100 hits a divot in the ground and the cylinder rod 202 may bottom out and completely extend as much as possible and expands the first chamber 610. As the first chamber 610 expands and the pressure of the hydraulic fluid in the first chamber 610 decreases, at least a portion of the stored hydraulic fluid in the first accumulator 210 and/or the second accumulator 212 can flow therefrom into the now expanded first chamber 610.

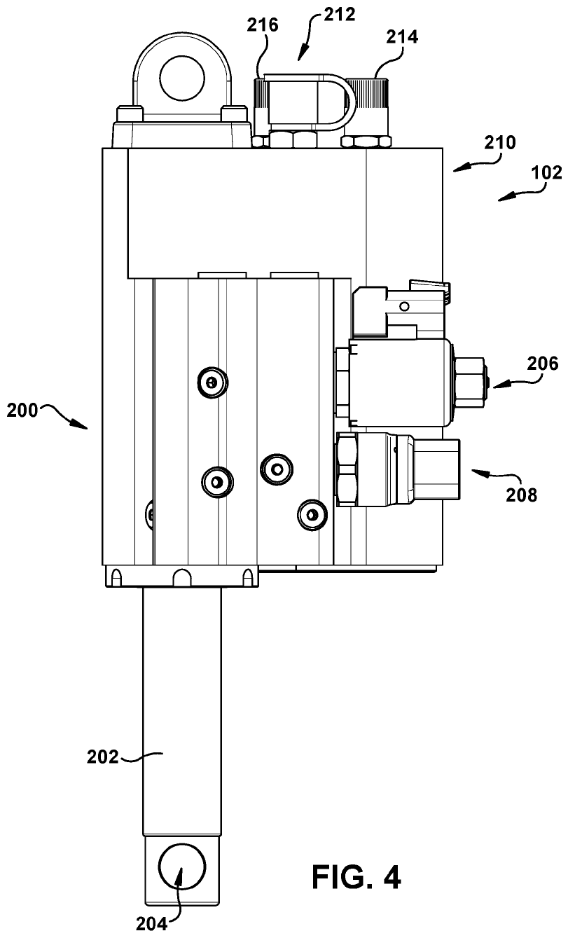

The hydraulic cylinder assembly 200, the first accumulator 210, and/or the second accumulator 212 can be placed in any suitable arrangement and retained in any suitable manner. In the embodiment illustrated in FIGS. 2-4, the hydraulic cylinder assembly 200, the first accumulator 210, and the second accumulator 212 are all retained in the same housing 218 to provide a compact product that provides the above described features of desired output force via the cylinder rod 202 while also including the retaining benefit of the accumulators 210 and 212. In one embodiment, the housing 218 can be formed of multiple components that are attachable to one another as desired. In the illustrated embodiment, the housing 218 is a single unitary component with the hydraulic cylinder assembly 200, the first accumulator 210, and the second accumulator 212 sealed in the unitary housing 218.

The hydraulic cylinder assembly 200, the first accumulator 210, and/or the second accumulator 212 can be placed in any suitable arrangement in the housing 218. In the embodiment illustrated in FIG. 5, a portion of the housing has been removed to see an interior of the housing 218 to reveal the arrangement of the hydraulic cylinder assembly 200, the first accumulator 210, and/or the second accumulator 212 within the housing 218. As can be seen in FIG. 5, the first accumulator 210 extends along a first longitudinal axis A, the second accumulator 212 extends along a second longitudinal axis B, and the hydraulic cylinder assembly 200 extends along a cylinder longitudinal axis C. To increase compactness of the downforce control system 102, the first longitudinal axis A, the second longitudinal axis B, and the cylinder longitudinal axis C are arranged parallel to one another. Additionally, the first longitudinal axis A, the second longitudinal axis B, and the cylinder longitudinal axis C are offset from one another further decrease the amount of space needed between the hydraulic cylinder assembly 200, the first accumulator 210, and/or the second accumulator 212 in the housing 218.

As can further be seen in FIG. 5, the hydraulic cylinder assembly 200 further includes a port 500 in a cylinder body 502 that is fluidly connected to the supply port 300, the return port 302, the first accumulator 210, and/or the second accumulator 212. Accordingly, the hydraulic fluid can flow into and out of the hydraulic cylinder assembly 200 (and by extension the first chamber 610) via the port 500. The port 500 can be placed at any suitable location on the cylinder body 502 and in the illustrated embodiment the port 500 is arranged at the base of the cylinder body 502 to limit the amount of fluid tubing needed inside the housing 218 since the corresponding ports for the first accumulator 210 and the second accumulator 212 are also near the base of their respective accumulators 210 and 212.

Turning now to FIG. 6a, illustrated is a cross-sectional view of the cylinder body 502 and the cylinder rod 202. The hydraulic cylinder assembly 200 includes a rod wear band 600 that is arranged between the cylinder rod 202 and an interior surface 602 of the cylinder body 502 to space the cylinder rod 202 from the surface 602 to limit and/or prevent wear on the cylinder rod 202 and/or the surface 602. Because the port 500 is near the base of the cylinder body 502, the hydraulic fluid when first inserted into hydraulic cylinder assembly 200 is trapped between the cylinder rod 202, the surface 602, and the rod wear band 600. However, to propel the cylinder rod 202 downward with respect to the cylinder body 502, the hydraulic fluid needs to be in the first chamber 610 on the other side of rod wear band 600. Accordingly, the cylinder rod 202 includes a rod communication port 604 shaped to fluidly connect the side of cylinder rod 202 and the first chamber 610 to move the hydraulic fluid between the first chamber 610 and the side of the cylinder rod 202.

The rod communication port 604 can include any suitable shape, size, and/or configuration for this hydraulic fluid movement. In the illustrated embodiment, the rod communication port 604 comprises a T-shaped path with opposing openings 606 on sides of the cylinder rod 202 that are then in communication with the opening 608 on the top of the cylinder rod 202. The cylinder rod 202 may further include a rod retention member 612 extending radially outwardly from a surface of the cylinder rod 202 that engages a corresponding stop surface 614 in the cylinder body 502 to prevent the cylinder rod 202 from extending out of the cylinder body 502 beyond a threshold amount. In the illustrated embodiment, the rod retention member 612 is configured as a rod retention ring that is attached to the radially outer surface of the cylinder rod 202 and which is configured to engage the corresponding stop surface 614. It is understood, however, that different rod retention members may be used, such as an integral and unitary protruding portion of the outer surface of the cylinder rod 202, a pin pressed into the side of the cylinder rod 202, or the like.

As noted above, the internal pressure of each of the accumulators 210 and 212 can be generated via any suitable system and/or mechanism, and it may depend on the configuration of the accumulator. Illustrated in FIG. 6b is a cross-sectional view of the first accumulator 210 in an embodiment where the first accumulator 210 comprises a piston accumulator. A first charge amount of a fluid, such as gas, can be provided in a chamber 618 on a side of the piston 616 (via charge port 214) to press the piston 616.

In an example, the first charge amount can be in a range of 50 psi to 500 psi, more particularly, the range can be 100 psi to 400 psi, yet even more particularly, the range can be 150 psi to 200 psi. In an exemplary embodiment, the range of the first charge amount is 150 psi to 500 psi. Similar to the first accumulator 210 embodiment illustrated in FIG. 6b, the second accumulator 212 can be a piston accumulator with a second charge amount of a fluid, such as gas, provided in a chamber on a side of the piston (via charge port 216) to press the piston. In another example, the second charge amount can be in a range of 500 psi to 2000 psi, more particularly, the range can be 750 psi to 1500 psi, even more particularly, the range can be 1000 psi to 1250 psi.

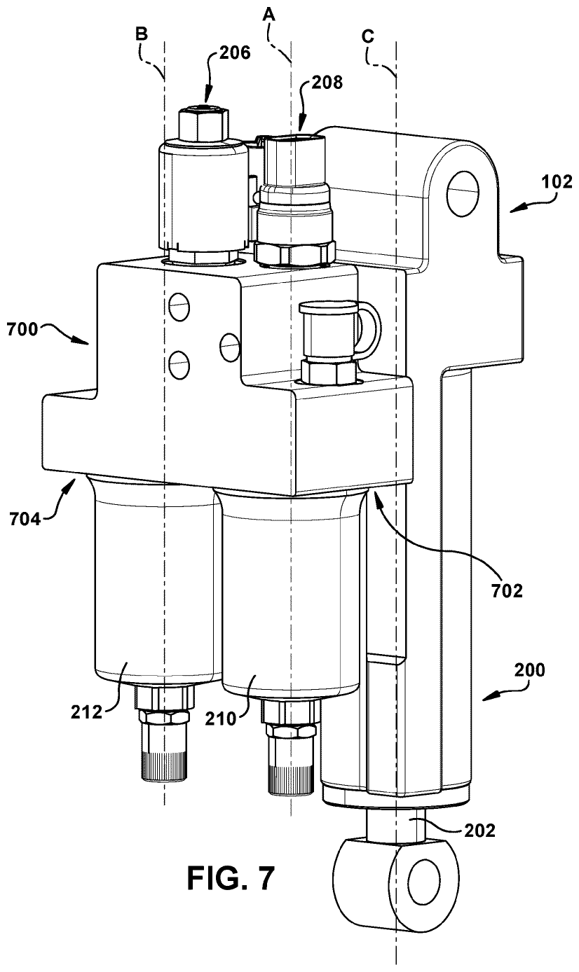

Turning now to FIG. 7, illustrated is another embodiment of the downforce control system 102 with a different arrangement that includes the threshold functionality of the accumulators 210 and 212 described above. The illustrated downforce control system 102 includes a mount portion 700 that are attached to and extend from the hydraulic cylinder assembly 200 and the mount portion 700 includes the proportional control valve 206, the pressure sensor 208, the supply port 300, and/or the return port 302. In contrast to the embodiments described above where the accumulators 210 ands 212 are sealed in the housing 216, the first accumulator 210 and/or the second accumulator 212 can be detachably attached to the mount portion 700 to allow a user to swap out accumulators as desired.

Accordingly, the mount portion 700 can further include a first mount 702 for releasably fluidly connecting the first accumulator 210 to the mount portion 700 and a second mount 704 for fluidly connecting the second accumulator 212 to the mount portion 700. The mount portion 700 may further include fluid tubing to fluidly connect the hydraulic cylinder assembly 200, the first accumulator 210, and/or the second accumulator 212.

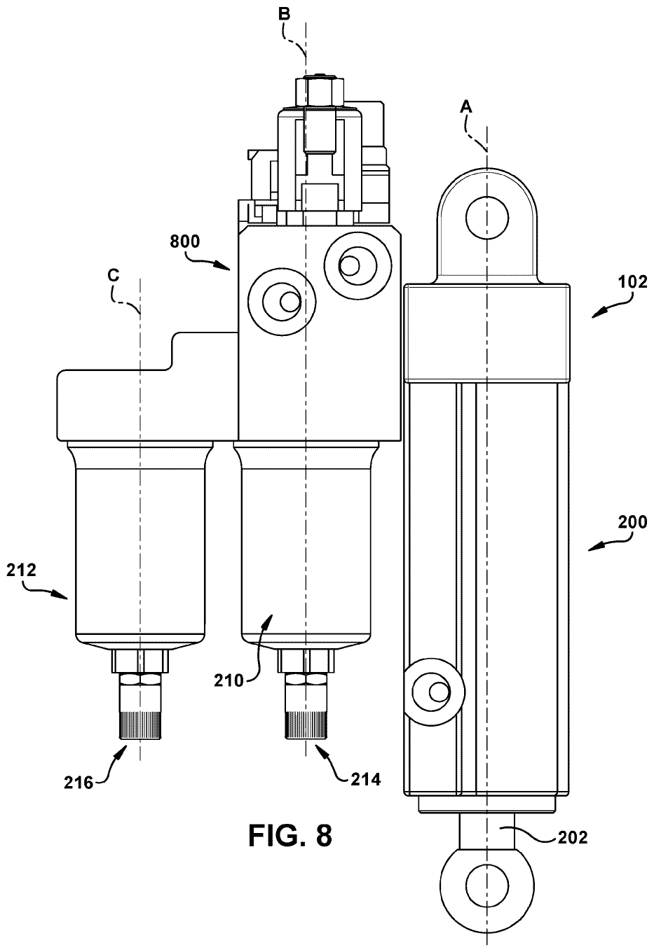

As can be seen in FIG. 7, the mount portion 700 is configured such that the first longitudinal axis A, the second longitudinal axis B, and the cylinder longitudinal axis C are offset from one another in different planes. In contrast, the mount portion 800 of FIG. 8 is configured such that the first longitudinal axis A, the second longitudinal axis B, and the cylinder longitudinal axis C are offset from one another but along the same plane.

According to an aspect of the disclosure, a downforce control system for an agricultural ground engaging unit, comprises: a hydraulic cylinder assembly including a cylinder chamber elongated along a longitudinal axis, and a cylinder rod movable in the cylinder chamber along the longitudinal axis, wherein hydraulic fluid in the cylinder chamber provides a downforce on the cylinder rod to downwardly bias the agricultural ground engaging unit; and a first accumulator and second accumulator, the first and second accumulators each being fluidly coupled to the cylinder chamber to receive at least a portion of the hydraulic fluid as the cylinder rod moves in the cylinder chamber and displaces hydraulic fluid from the cylinder chamber, wherein each of the first and second accumulators is elongated along a respective longitudinal axis, the respective longitudinal axes of the accumulators being offset and parallel to each other, and being offset and parallel to the longitudinal axis of the cylinder chamber.

Exemplary embodiments may include one or more of the following additional features, separately or in any combination.

In exemplary embodiment(s), wherein the first accumulator and the second accumulator each have a hydraulic chamber that is elongated along the respective longitudinal axes of the accumulators.

In exemplary embodiment(s), wherein the hydraulic cylinder, the first accumulator, and the second accumulator are contained within a unitary housing, wherein the housing further includes internal passages that fluidly connect the first and second accumulators with the first chamber of the hydraulic cylinder.

In exemplary embodiment(s), further comprising a mount portion extending from the hydraulic cylinder, wherein the mount portion includes a first and second mount to releasably fluidly attach the first and second accumulator to the mount portion to fluidly connect to the hydraulic cylinder.

In exemplary embodiment(s), wherein the first and/or second accumulators are at least one of bladder accumulators or piston accumulators.

In exemplary embodiment(s), wherein the hydraulic cylinder is a single acting hydraulic cylinder.

In exemplary embodiment(s), wherein the cylinder rod has a stop to prevent further movement of the cylinder rod beyond a predetermined extension from the hydraulic cylinder.

In exemplary embodiment(s), further comprising: a supply valve fluidly coupled to the first chamber to selectively provide the hydraulic fluid; and a return valve fluidly coupled to the first chamber, the first accumulator, and the second accumulator to selectively remove at least a second portion of the hydraulic fluid.

In exemplary embodiment(s), wherein the longitudinal axis of the first accumulator, the longitudinal axis of the second accumulator, and the cylinder longitudinal axis are offset from each other and are all in a single plane.

In exemplary embodiment(s), wherein the cylinder rod includes a rod communication port configured for flow of the hydraulic fluid between a first side of the cylinder rod and a second side of the cylinder rod.

In exemplary embodiment(s), wherein the cylinder rod further includes a rod retention member that extends outwardly from a body of the cylinder rod.

In exemplary embodiment(s), wherein the hydraulic cylinder further includes a surface on an interior of a cylinder body configured to engage the rod retention member to prevent travel of the cylinder rod out of the cylinder body beyond a threshold point.

According to another aspect of the disclosure, a downforce control system for an agricultural ground engaging unit, comprises: a hydraulic cylinder assembly including a cylinder chamber elongated along a longitudinal axis, and a cylinder rod moveable along the longitudinal axis, wherein the hydraulic fluid in the cylinder chamber provides a downforce on the cylinder rod; a first accumulator in fluid communication with the first chamber, wherein the first accumulator has a first threshold pressure above which fluid can be received by the first accumulator; and a second accumulator in fluid communication with the first chamber, wherein the second accumulator has a second threshold pressure above which fluid can be received by the second accumulator, wherein the second threshold pressure is greater than the first threshold pressure, wherein the hydraulic cylinder, the first accumulator, and the second accumulator are configured such that (i.) at least a portion of the hydraulic fluid from the first chamber is received by the first accumulator when the pressure in the first chamber is above the first threshold pressure and (ii.) at least a second portion of the hydraulic fluid from the first chamber is received by the second accumulator when the pressure in the first chamber is above the second threshold pressure, wherein the first and second accumulators each extend along a respective longitudinal axis that are offset and parallel to each other and are each offset and parallel to the cylinder longitudinal axis.

Exemplary embodiments may include one or more of the following additional features, separately or in any combination.

In exemplary embodiment(s), wherein the first accumulator comprises an accumulator with a first gas charge amount on a gas side of the first accumulator, wherein the second accumulator comprises an accumulator with a second gas charge amount on a gas side of the second accumulator.

In exemplary embodiment(s), wherein the first charge amount is in a range of 125 psi to 500 psi, wherein the second charge amount is in a range of 500 psi to 2000 psi.

In exemplary embodiment(s), wherein at least one of the first accumulator or the second accumulator comprises a piston accumulator or a bladder accumulator.

In exemplary embodiment(s), further comprising a sensor configured to detect the pressure in the first chamber.

In exemplary embodiment(s), wherein when an external compressive force on the cylinder rod compresses the hydraulic fluid in the first chamber increasing the pressure in the first chamber, at least a portion of the hydraulic fluid flows out of the first chamber and into the first accumulator.

In exemplary embodiment(s), wherein when an external compressive force on the cylinder rod compresses the hydraulic fluid in the first chamber increasing the pressure in the first chamber, at least a first portion of the hydraulic fluid flows out of the first chamber and into the first accumulator and at least a second portion of the hydraulic fluid flows out of the first chamber and into the second accumulator.

In exemplary embodiment(s), wherein the hydraulic cylinder, the first accumulator, and the second accumulator are contained within a unitary housing, wherein the housing further includes internal passages that fluidly connect the first and second accumulators with the first chamber of the hydraulic cylinder.

The term “or” as used herein is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Additionally, as used herein, the term “exemplary” is intended to mean serving as an illustration or example of something and is not intended to indicate a preference.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A downforce control system for an agricultural ground engaging unit, comprising:
a hydraulic cylinder assembly including a cylinder chamber elongated along a longitudinal axis, and a cylinder rod movable in the cylinder chamber along the longitudinal axis, wherein hydraulic fluid in the cylinder chamber provides a downforce on the cylinder rod to downwardly bias the agricultural ground engaging unit; and
a first accumulator and second accumulator, the first and second accumulators each being fluidly coupled to the cylinder chamber to receive at least a portion of the hydraulic fluid as the cylinder rod moves in the cylinder chamber and displaces hydraulic fluid from the cylinder chamber,
wherein each of the first and second accumulators is elongated along a respective longitudinal axis, the respective longitudinal axes of the accumulators being offset and parallel to each other, and being offset and parallel to the longitudinal axis of the cylinder chamber.

2. The downforce control system of claim 1, wherein the first accumulator and the second accumulator each have a hydraulic chamber that is elongated along the respective longitudinal axes of the accumulators.

3. The downforce control system of claim 1, wherein the hydraulic cylinder, the first accumulator, and the second accumulator are contained within a unitary housing, wherein the housing further includes internal passages that fluidly connect the first and second accumulators with the chamber of the hydraulic cylinder.

4. The downforce control system of claim 1, further comprising a mount portion extending from the hydraulic cylinder, wherein the mount portion includes a first and second mount to releasably fluidly attach the first and second accumulator to the mount portion to fluidly connect to the hydraulic cylinder.

5. The downforce control system of claim 1, wherein the first and/or second accumulators are at least one of bladder accumulators or piston accumulators.

6. The downforce control system of claim 1, wherein the hydraulic cylinder is a single acting hydraulic cylinder.

7. The downforce control system of claim 6, wherein the cylinder rod has a stop to prevent further movement of the cylinder rod beyond a predetermined extension from the hydraulic cylinder.

8. The downforce control system of claim 1, further comprising:
a supply valve fluidly coupled to the chamber of the hydraulic cylinder to selectively provide the hydraulic fluid; and
a return valve fluidly coupled to the chamber of the hydraulic cylinder, the first accumulator, and the second accumulator to selectively remove at least a second portion of the hydraulic fluid.

9. The downforce control system of claim 1, wherein the longitudinal axis of the first accumulator, the longitudinal axis of the second accumulator, and the cylinder longitudinal axis are offset from each other and are all in a single plane.

10. The downforce control system of claim 1, wherein the cylinder rod includes a rod communication port configured for flow of the hydraulic fluid between a first side of the cylinder rod and a second side of the cylinder rod.

11. The downforce control system of claim 10, preceding claim, extends outwardly from a body of the cylinder rod.

12. The downforce control system of claim 11, wherein the hydraulic cylinder further includes a surface on an interior of a cylinder body configured to engage the rod retention member to prevent travel of the cylinder rod out of the cylinder body beyond a threshold point.

13. A downforce control system for an agricultural ground engaging unit, comprising:
a hydraulic cylinder assembly including a cylinder chamber elongated along a longitudinal axis, and a cylinder rod moveable along the longitudinal axis, wherein the hydraulic fluid in the cylinder chamber provides a downforce on the cylinder rod;
a first accumulator in fluid communication with the chamber of the hydraulic cylinder, wherein the first accumulator has a first threshold pressure above which fluid can be received by the first accumulator;
a second accumulator in fluid communication with the chamber of the hydraulic cylinder, wherein the second accumulator has a second threshold pressure above which fluid can be received by the second accumulator, wherein the second threshold pressure is greater than the first threshold pressure,
wherein the hydraulic cylinder, the first accumulator, and the second accumulator are configured such that (i.) at least a portion of the hydraulic fluid from the chamber of the hydraulic cylinder is received by the first accumulator when the pressure in the chamber of the hydraulic cylinder is above the first threshold pressure and (ii.) at least a second portion of the hydraulic fluid from the chamber of the hydraulic cylinder is received by the second accumulator when the pressure in the chamber of the hydraulic cylinder is above the second threshold pressure,
wherein the first and second accumulators each extend along a respective longitudinal axis that are offset and parallel to each other and are each offset and parallel to the cylinder longitudinal axis; and
wherein the first accumulator comprises an accumulator with a first gas charge amount on a gas side of the first accumulator, wherein the second accumulator comprises an accumulator with a second gas charge amount on a gas side of the second accumulator.

14. The downforce control system of claim 13, wherein the first charge amount is in a range of 861.845 kPa to 3447.38 kPa, wherein the second charge amount is in a range of 3447.38 kPa to 13,789.51 kPa.

15. The downforce control system of claim 13, wherein at least one of the first accumulator or the second accumulator comprises a piston accumulator or a bladder accumulator.

16. The downforce control system of claim 13, further comprising a sensor configured to detect the pressure in the chamber of the hydraulic cylinder.

17. The downforce control system of claim 13, wherein the hydraulic cylinder is configured so that an external compressive force on the cylinder rod compresses the hydraulic fluid in the chamber of the hydraulic cylinder, increasing the pressure in the chamber of the hydraulic cylinder, and at least a portion of the hydraulic fluid flows out of the chamber of the hydraulic cylinder and into the first accumulator.

18. The downforce control system of claim 13, wherein the hydraulic cylinder is configured so that when an external compressive force on the cylinder rod compresses the hydraulic fluid in the chamber of the hydraulic cylinder, the pressure in the chamber of the hydraulic cylinder is increased and at least a first portion of the hydraulic fluid flows out of the chamber of the hydraulic cylinder and into the first accumulator and at least a second portion of the hydraulic fluid flows out of the chamber of the hydraulic cylinder and into the second accumulator.

19. The downforce control system of claim 13, wherein the hydraulic cylinder, the first accumulator, and the second accumulator are contained within a unitary housing, wherein the housing further includes internal passages that fluidly connect the first and second accumulators with the chamber of the hydraulic cylinder.

20. (canceled)
